(19) United States
(12) Patent Application Publication
(10) Pub. No.: US 2014/0310628 A1
(43) Pub. Date: Oct. 16, 2014

(54) INTERACTIVE DISPLAYING OF DATABASE QUERIES

(71) Applicant: PYRAMID ANALYTICS BV, Amsterdam (NL)

(72) Inventors: Avi Perez, New Haven, CT (US); Herbert Ochtman, Hamden, CT (US); Omri Kohl, Tel Aviv (IL)

(73) Assignee: PYRAMID ANALYTICS BV, Amsterdam (NL)

(21) Appl. No.: 13/807,927

(22) PCT Filed: Dec. 26, 2012
(86) PCT No.: PCT/IB2012/057724

§ 371 Date: Jan. 1, 2013

Related U.S. Application Data
(60) Provisional application No. 61/580,265, filed on Dec. 26, 2011.

(51) Int. Cl. G06F 17/30; G06F 3/0484

(52) U.S. Cl. CPC G06F 17/30557; G06F 3/04842
USPC 715/771

(57) ABSTRACT

To present a plurality of views of a plurality of database queries, each of which has a respective plurality of dimensions, each dimension including a plurality of elements, upon receipt, from a user, of a selection of a set of the elements of one of the dimensions of a first query, the set is parameterized. A simultaneous display of the views is presented to the user via a GUI. Upon receipt from the user, via an input device of the GUI, of an instruction to propagate the parameter from a source field displayed by the GUI to one or more target views, the parameter is so propagated.

### FIELD AND BACKGROUND OF THE INVENTION

The present invention relates to the display of database queries and, more particularly, to a method of propagating “parameters” (as defined below) among displays of one or more database queries.

A “database query”, or a “query” for short, as understood herein, is a set of data retrieved from a database as a multidimensional dataset. Each datum of the dataset is associated with a particular n-tuple of values of the dimensions. For example, a user of relational database software may request values of sales volumes and revenues for a set of countries and a set of years. The query returned by the software has three dimensions: sales, geographic locations (countries) and dates (years). The coordinates of the n-tuples are discrete values of the dimensions. In this example, the values of “sales” are “volume” and “revenue”, the values of “countries” could be “Belgium” “Netherlands” and “Luxembourg” and the values of “years” could be “2010”, “2011” and “2012”. A typical datum of the query could be a value of “sales volume in Belgium in 2011”, associated with the triplet “volume, Belgium, 2011”.

Typically, the query is displayed by a graphical user interface (GUI) of a computer system as a table. Because the GUI is two-dimensional and typical queries have three or more dimensions, the table displays data for several values of each of two of the dimensions and one value of each of the other dimensions. For example, sales volumes could be displayed in a table for all three countries (as the rows of the table) and for all three years (as the columns of the table). More generally, the query can be thought of as a data hypercube whose axes are the dimensions of the query and from which two-dimensional tables are selected for display by cutting the hypercube parallel to its axes. This operation is conventionally called “slicing” the query. As defined herein, for any particular displayed table, the row and column dimensions of the table are “explicit dimensions” of the query as displayed and the other dimension(s) is/are “implicit dimensions” of the query as displayed.

Other methods of displaying a portion of the query are known. For example, sales volumes for a particular year could be displayed as a color-coded map of countries, with each country being colored with a color that indicates its sales volume for that year.

Conventionally, the user interacts directly with the query via the GUI in the following ways:

1. Slicing, as described above.

2. Dicing. The user selects a sub-hypercube of the hypercube for display. In the above example, the sub-cube could be sales volumes for all three countries in the year 2011, displayed as a color coded map. “Dicing” also may rotate the sub-hypercube, to change the displayed dimensions.

3. Drill down/up. Suppose the actual coordinate values of the above examples were months in the years 2010-2012 (36 in all) and the individual provinces of Belgium (eleven, including the Brussels Capital Region as a “province”), Netherlands (twelve) and Luxembourg (treated as a single province) (24 in all). The lowest level table of sales volume or sales revenue would have 24 rows and 36 columns. The lowest-level values of a dimension are called herein the “elements” or the “elemental values” of the dimension. The highest level table of sales volume or sales revenue would have a single row (“Benelux”) and a single column (“2010-2012”), and the single datum displayed would be the sum of all the sales volumes or the sum of all the sales revenues in the query. “Drilling down” from a higher level means making the table more detailed. For example, the query could be “drilled down” from the highest level table to show data for individual countries or individual provinces or for the three individual years or for the 36 individual months. Going in the other direction, “drilling up” from a low-level table produces a high-level table whose data as displayed are combinations (typically sums) of the data of the low-level table. These combined data are associated with n-tuples of “sets” of elements of the dimensions. For example, one of the n-tuples produced by drilling up from months to years is (Luxembourg, 2010, revenue) in which “2010” is a set whose members are the months January 2010 through December 2010. The elements themselves are special cases of sets with just one member each.

4. Roll-up: Summarize the data along a particular dimension. Drilling up to turn a low-level table into a high-level table is one example of roll-up. The roll-up could also be a function of the elements. For example, if one of the dimensions is “revenue”, with elemental values “sales” and “expenses”, that dimension could be rolled up into “profits”=“sales”−“expenses”.

More sophisticated analyses of queries can be performed, but until recently such analyses conventionally could not be done just by interacting with the GUI. Until the present inventors developed the “parameterization” described in PCT Application No. IB2012/057360 filed on 17 Dec. 2012 and titled “METHOD OF FACILITATING MANIPULATION OF A DATABASE QUERY”, which PCT Application is incorporated by reference for all purposes as if fully set forth herein, such analyses required the user to write scripts in a database query language such as MDX. Some vendors provided menu-driven wizards for facilitating such analyses, but these wizards, too, had to be run by the user separately from the displaying of the query in the GUI.

As noted above, every database query has two or more dimensions, each of which generally includes a plurality of elements. Every n-tuple of the elements has associated with it one datum of the data of the query.

Prior to “parameterization”, the elements of a database query, as displayed by database management software at a GUI, are static values. “Parameterization” functionalizes a display of a database query by the GUI. The database management software is modified so that the elements of a database query can be transformed, either individually or as sets of two or more elements, into parameters of the database query such that values of the parameters can be changed merely by using the GUI to edit those values. The database query as displayed, now being a function of the parameters, changes automatically in response to the change in the parameter values. For example, if one of the dimensions of a database query is “time”, whose elements are months, changing “month” to a parameter enables display of data for a particular month merely by using the GUI to edit the displayed value of the month, rather than e.g. drilling up to the year level and then drilling down back down to the desired month; and defining a range of months as a vectorial parameter enables a change of a display of data from one range of months to another range of months merely by using the GUI to edit the displayed values of the initial and/or final months.

### SUMMARY OF THE INVENTION

The technology described in PCT Application No. IB2012/057360 parameterizes individual displays. The present invention facilitates the propagation of such parameterization among several displays.

According to the present invention there is provided a method of presenting, on a computer system, a plurality of views of a plurality of database queries, each database query having a respective plurality of dimensions, with each dimension including a plurality of elements, the method including: (a) receiving, from a user of the computer system, a selection of a set of the elements of one of the dimensions of a first one of the database queries to parameterize; (b) in response to the selection: parameterizing the set, thereby transforming the set into a parameter; (c) presenting, to said user, a display of the views simultaneously using a graphical user interface (GUI) of the computer system; (d) receiving, from the user, via an input device of the GUI, at least one instruction to propagate the parameter from a source field displayed by the GUI to at least one of the views that is a target view of the instruction; and (e) in response to the instruction: propagating the parameter to the at least one target view.

According to the present invention there is provided a computer-readable storage medium having non-transient computer-readable code embodied on the computer-readable storage medium, the computer-readable code for presenting, on a computer system, a plurality of views of a plurality of database queries, each database query having a respective plurality of dimensions, with each dimension including a plurality of elements, the computer-readable code including: (a) program code for receiving, from a user of the computer system, a selection of a set of the elements of one of the dimensions of a first one of the database queries to parameterize; (b) program code for, in response to the selection: parameterizing the set, thereby transforming the set into a parameter; (c) program code for presenting, to said user, a display of the views simultaneously using a graphical user interface (GUI) of the computer system; (d) program code for receiving, from the user, via an input device of the GUI, at least one instruction to propagate the parameter from a source field displayed by the GUI to at least one of the views that is a target view of the instruction; and (e) program code for, in response to the instruction: propagating the parameter to the at least one target view.

The methods of the preset invention are methods of presenting, on a computer system, one or more respective views of each of two database queries. Each database query has two or more dimensions, each of which includes a plurality of elements.

In the basic method of the invention, the computer system receives from a user a selection of, for one of the dimensions of a first one of the database queries, a set of elements to parameterize. The set may include just one element or may include several elements. For example, in the preferred embodiments below, the “time” parameter corresponds to one element if the basic elements of the “time” dimension are years, and to sets of several elements if the basic elements of the “time” dimension are shorter time intervals such as months. In response to the selection, the set is parameterized, thereby transforming the set into a parameter. A GUI is used to present to the user a simultaneous display of the views. One or more instructions are received from the user, via a GUI input device such as a mouse, a mousepad or a stylus, to propagate the parameter, from a source field that is displayed by the GUI, to at least one of the views that is a target view of the instruction. In response to the instruction, the parameter is propagated to the target view(s).

Preferably, the selection of the set of elements to parameterize is received via the GUI.

The source field may be separate from the views, as in the case of the “time” parameter in the preferred embodiments below. Alternatively, the source field is a view of the first database query, and the target view(s) include(s) a view of a second database query, as in the case of the “financials” views in the preferred embodiments below.

Preferably, the instruction(s) is/are (a) graphical instruction(s), i.e., (an) instruction(s) to draw (a) geometric object(s) such as the lines drawn in FIGS. 4-8 below from source fields to target views, as opposed to textual instructions such as instructions selected by selecting keys of a virtual keyboard displayed by a GUI.

The scope of the invention also includes a computer-readable storage medium bearing non-transient computer-readable code for implementing the invention.

### BRIEF DESCRIPTION OF THE DRAWINGS

Various embodiments are herein described, by way of example only, with reference to the accompanying drawings, wherein:

FIG. 1 shows a display of exemplary views of several database queries;

FIG. 2 shows the creation of a global “year” parameter;

FIG. 3 shows the newly created global parameter in a separate field;

FIGS. 4-6 show the propagation of parameters among the “financials” views;

FIGS. 7 and 8 show the propagation of the “year” parameter;

FIGS. 9, 12, 13 and 14 show the automatic propagation of a changed value of the “year” parameter;

FIG. 10 shows the automatic propagation of a changed value of the “location” parameter;

FIG. 11 shows the automatic propagation of a drill-down of the “location” parameter;

FIG. 15 is a high-level partial block diagram of a computer system for implementing the method of the present invention.

### DESCRIPTION OF THE PREFERRED EMBODIMENTS

The principles and operation of the use of a GUI to display database queries according to the present invention may be better understood with reference to the drawings and the accompanying description.

As noted in PCT Application No. 1B2012/057360, “parameterization” of a database query is done by modifying multidimensional database management software to do “behind the back” of a user what the user could have done using unmodified multidimensional database management software but only with considerably more effort. The present invention extends that concept to modify the multidimensional database management software to interact with GUI software to, again, accomplish tasks that the user could have done using unmodified multidimensional database software but only with considerably more effort.

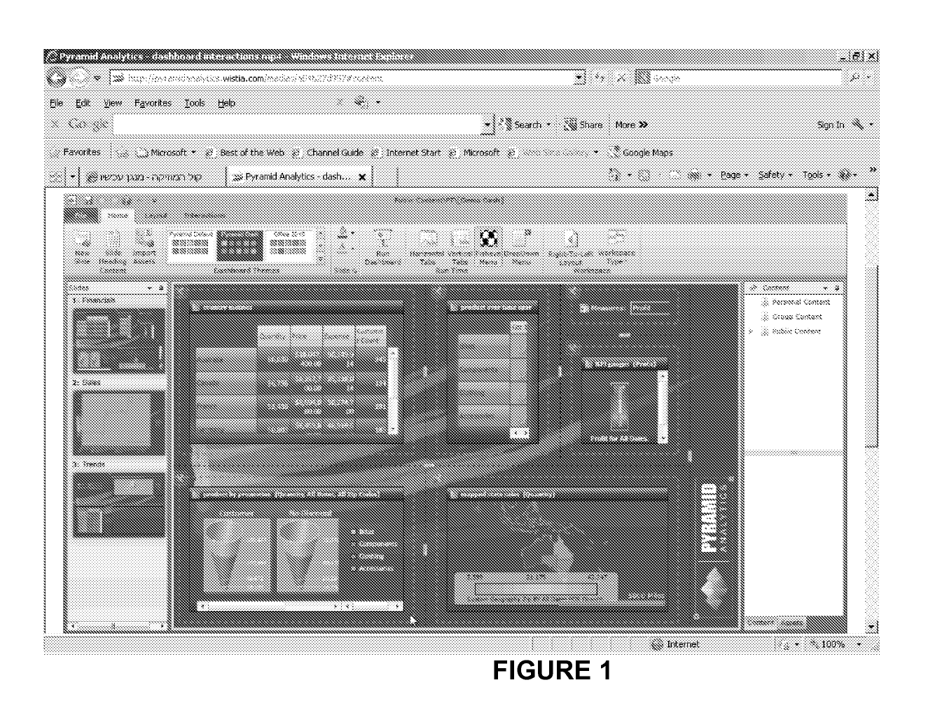

Referring now to the drawings, FIGS. 1-14 illustrate the application of the present invention to a set of database queries directed at a common database. The database queries are displayed in various formats on three displays, as shown in the extreme left-hand-side of FIG. 1: a “financials” display, a “sales” display and a “trends” display. The discussion herein focuses on the “financials” and “trends” displays. The “financials” display is of respective views of different but related database queries. The “trends” displays are four differently formatted views of the same database query.

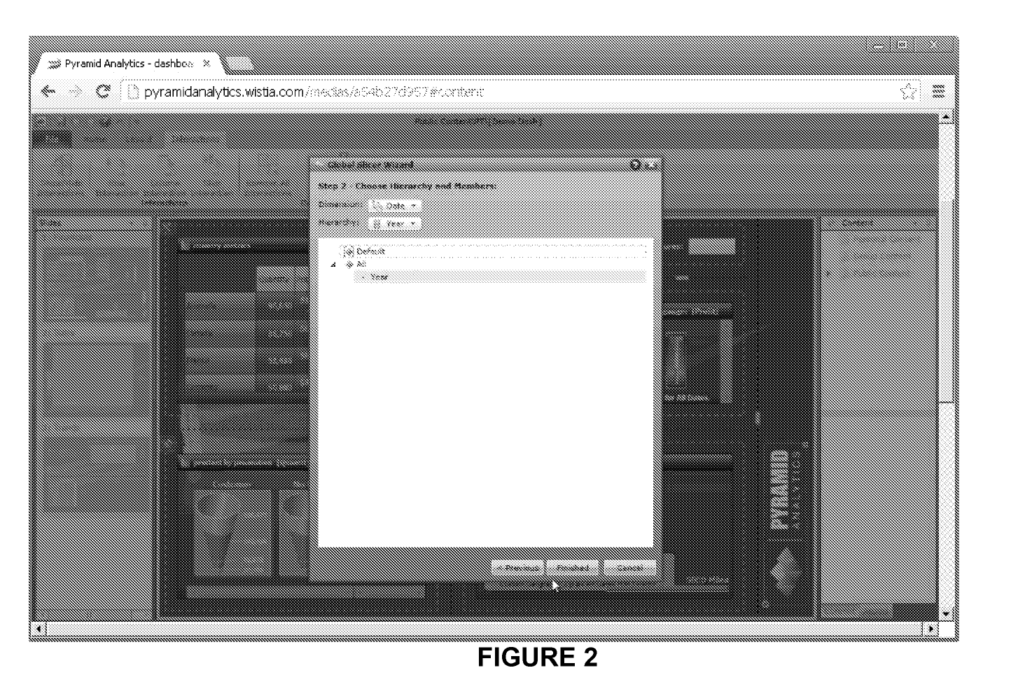

FIGS. 1, 4-6, 10 and 11 illustrate the propagation of parameters among the “financials” views. FIGS. 2, 3, 7-9 and 12-14 illustrate the propagation of a “global” parameter among all the views.

In FIG. 1, the database query of the upper left view is displayed as a table. The row dimension is “location”, the elements of which are zip codes of larger political units, e.g. of provinces of Australia or of counties of states of the United States of America. The column dimension is “financials”, the elements of which are “quantity”, “price”, “expense” and “customer count”. The third dimension is “time”, the elements of which are the years 2008-2010. The “location” and “financials” dimensions have previously been parameterized as described in PCT Application No. IB2012/057360, with the default value of “location” being “Australia” and the default value of “financials” being “quantity”. Note that “location” was parameterized on the country level, corresponding to a set of more than one of the elements of the “location” dimension.

FIG. 2 shows the creation of a global parameter, “year”, with a default value of “2008”, for all the views. Note that for this parameter to be propagated to a database query, the database query must have “time” as one of its dimensions, with the year 2008 being either an element of the dimension or a set of elements, for example months, of the dimension.

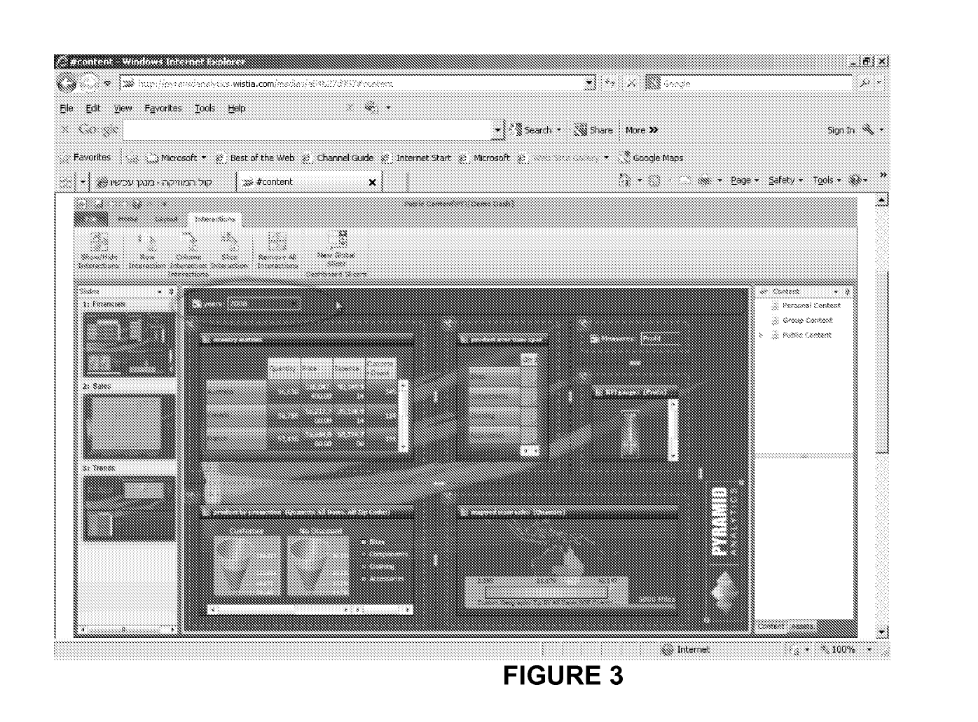

FIG. 3 shows the new global parameter in a field just above the upper left “financials” view.

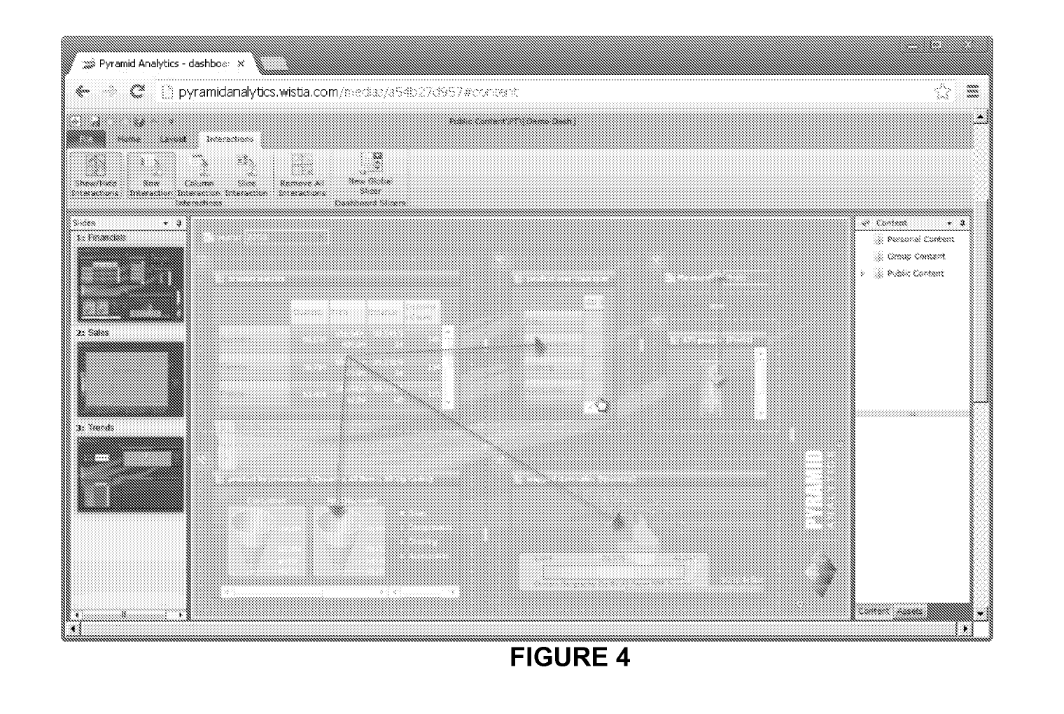

FIG. 4 shows the propagation of the “location” parameter from the upper left “financials” view (the “source view”) to the other “financials” views (the “target views”). The user uses a GUI input device such as a mouse, first to click on the second item from the left (“Row Interaction”) in the menu bar just above the views and then to draw lines from the upper left view to the other views. As in the case of the global parameter of FIG. 2, for this propagation to be valid the target views must be of queries that include among their dimensions a dimension compatible with the row dimension (“location”) of the query of the source view, with the default value (“Australia”) being either an element of the dimension (e.g. if the elements are countries) or a set of elements of the dimension (e.g. if the elements are provinces).

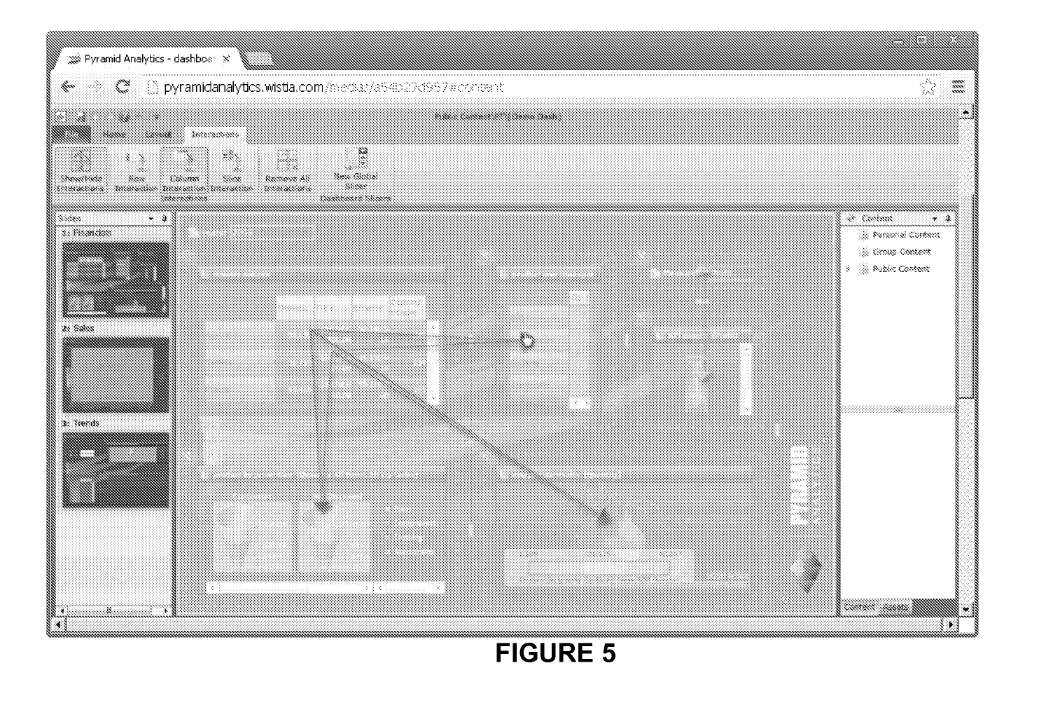

FIG. 5 shows a similar propagation of the “financials” parameter from the upper left “financials” view as the source view to the other “financials” views as the target views. The user uses the GUI input device, first to click on the third item from the left (“Column Interaction”) in the menu bar just above the views and then to draw lines from the upper left view to the other views.

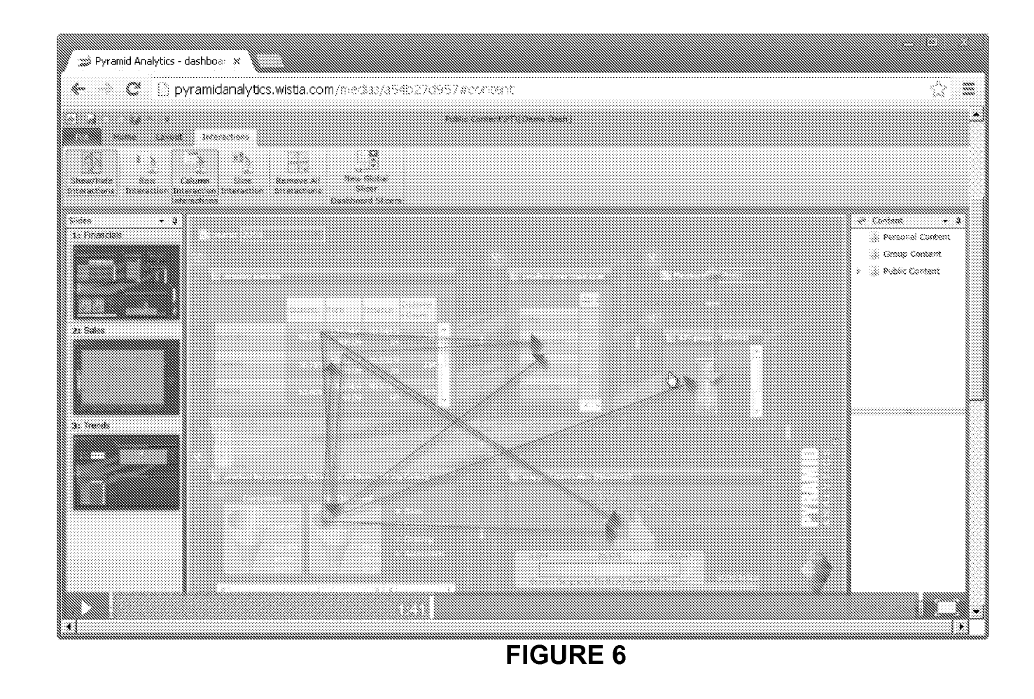

FIG. 6 shows a similar propagation of a parameter from the lower left “financials” view as the source view to the other “financials” views as the target views.

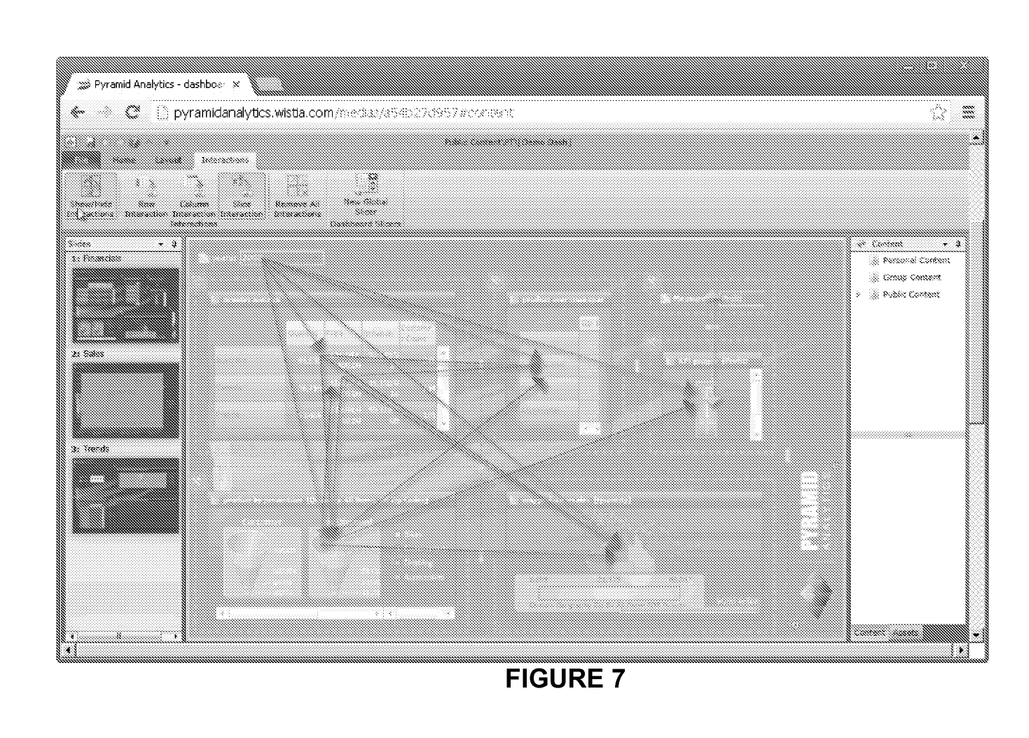

FIG. 7 shows the propagation of the global “year” parameter from the global parameter field as the source field to the “financials” views as target views.

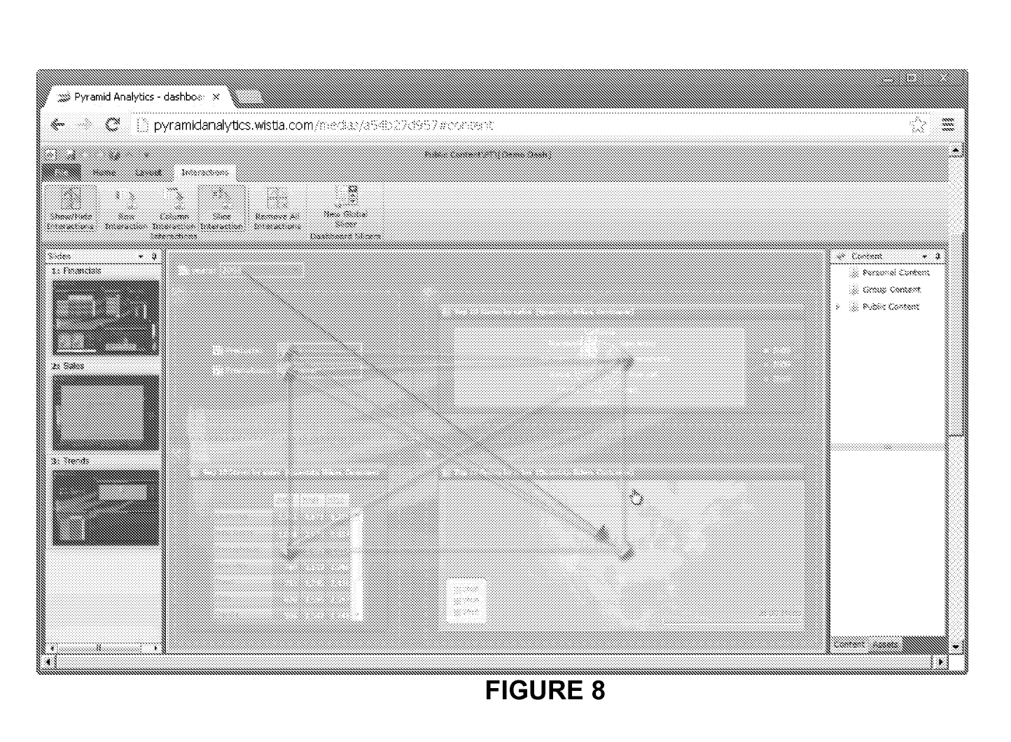

FIG. 8 shows the propagation of the global “year” parameter from the global parameter field as the source field to the “trends” views. Because all the “trends” views are views of the same database query, the user uses the GUI input device to draw only one line to one of the target views.

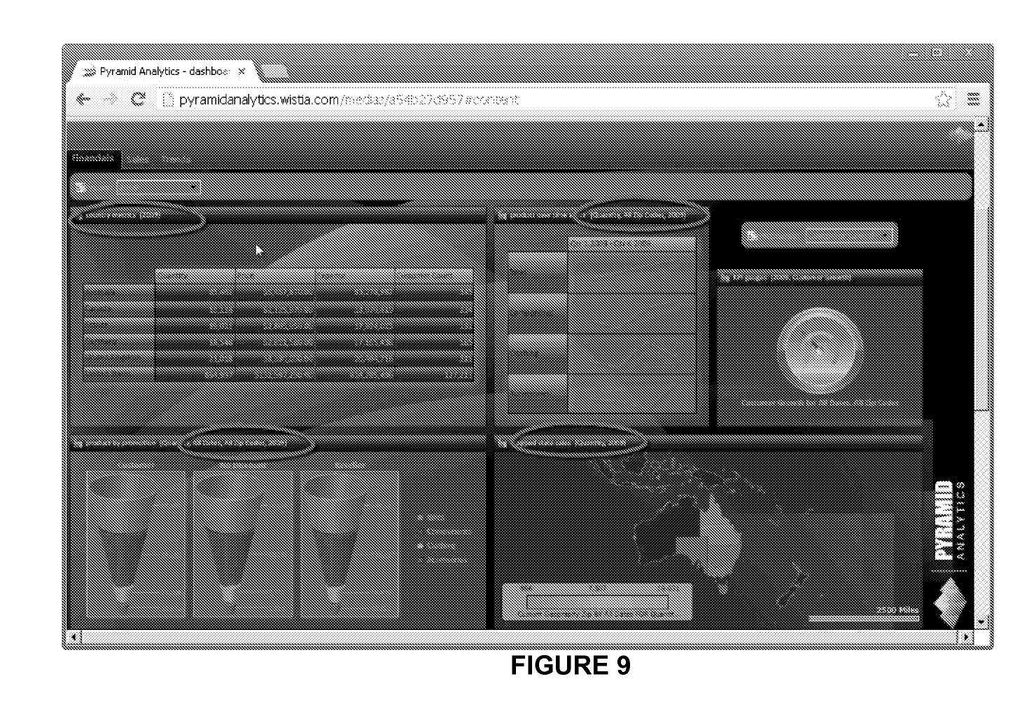

FIG. 9 shows the “financials” views after the value of “year” in the global parameter field has been changed to “2009”. That change has been automatically propagated to all the views, that now display data from the year 2009.

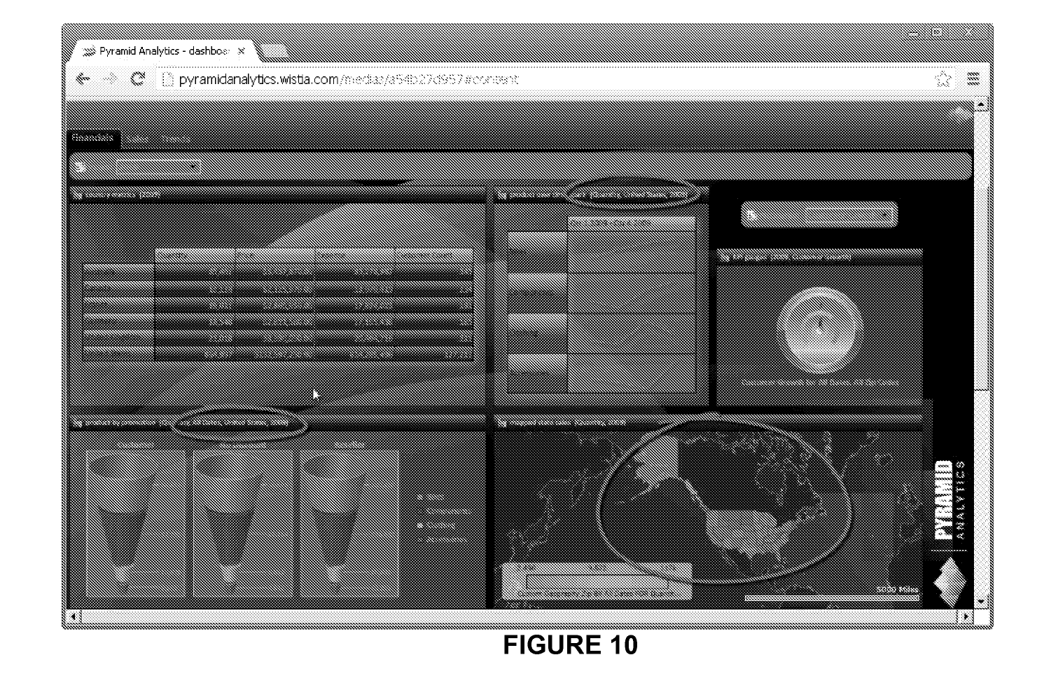

FIG. 10 shows the “financials” views after the value of the “location” parameter of the upper left view has been changed from “Australia” to “United States”. That change has been automatically propagated to all the other views. All the views now display data for the United States rather than data for Australia. Note in particular that the map in the lower right view now is a map of the United States rather than a map of Australia.

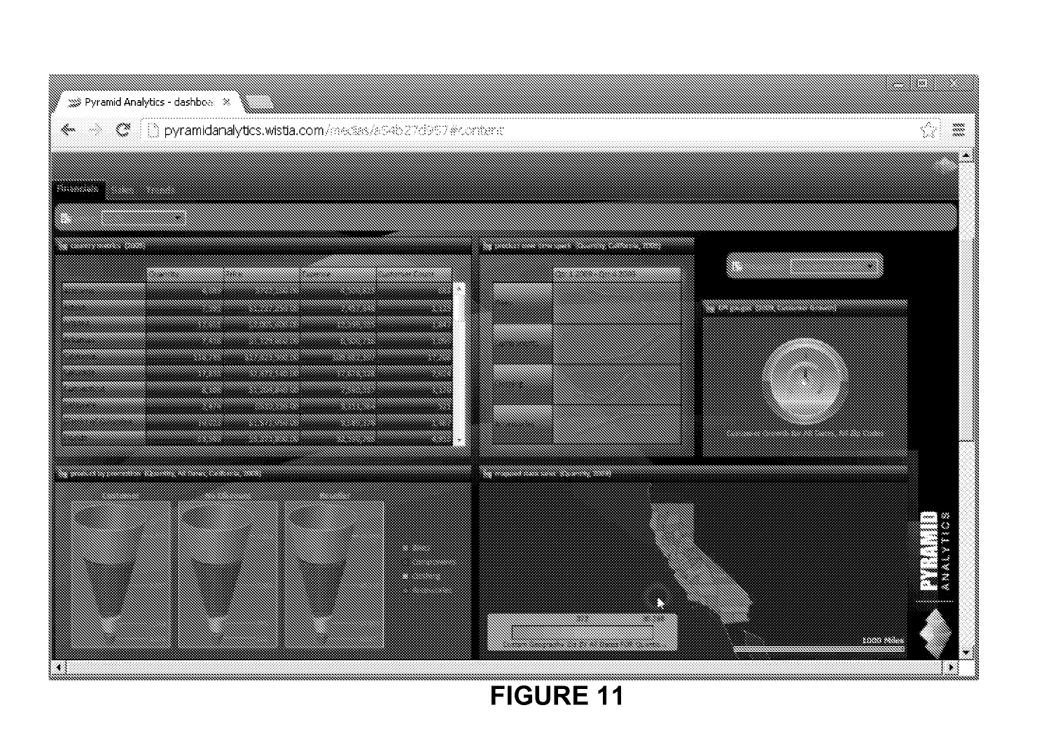

FIG. 11 shows the “financials” views after drilling down. to “California” in the upper left view. That change of the value of the “location” parameter has been automatically propagated to the other “financials” views. All the “financials” views now display data for California. Note in particular that the map in the lower right view now is a map of California.

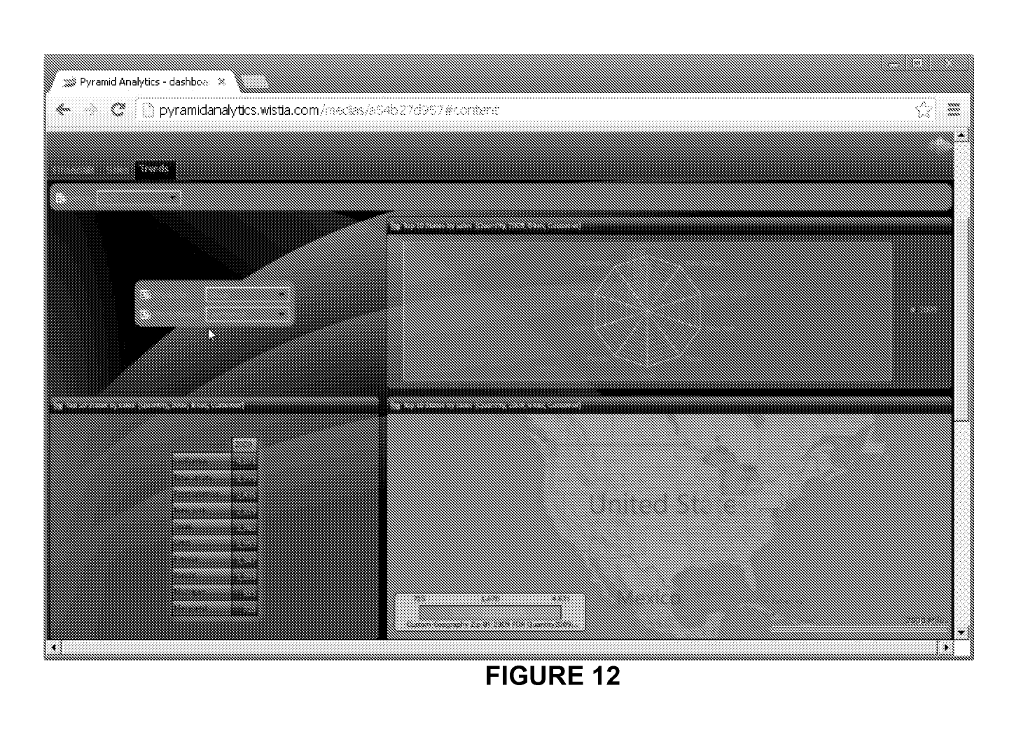

FIG. 12 shows that the change of the value of the global parameter to“2009”, that is shown in FIG. 9 as having been propagated to all the “financials” views, also has been propagated to all the “trends” views. All the “trends” views now display data from the year 2009.

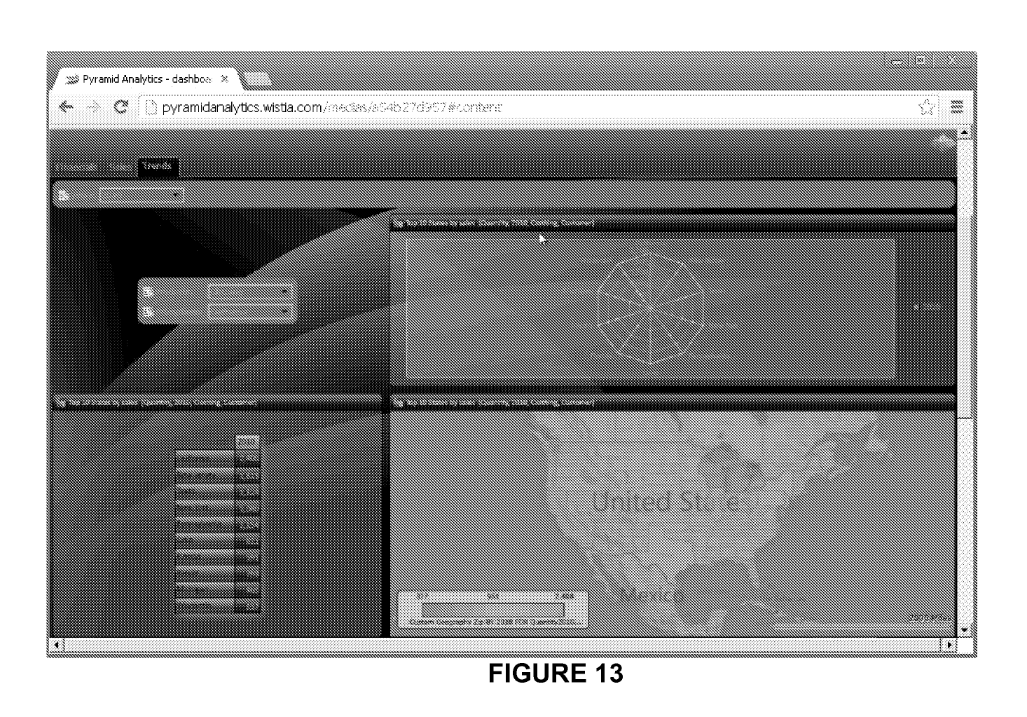

FIG. 13 shows the “trends” views after the value of the “year” in the global parameter field has been changed to “2010”. That change has been automatically propagated to all the views, that now display data from the year 2010.

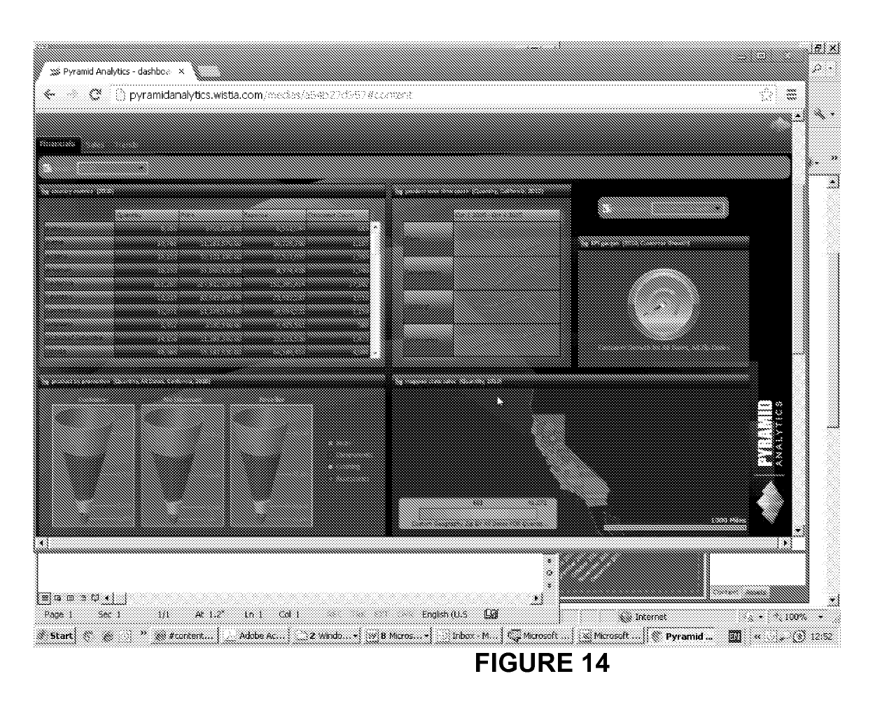

FIG. 14 shows that the change of the value of the global parameter to “2010” also has been propagated to all the “financials” views. All the “financials” views now display data from the year 2010.

Having seen these examples, those skilled in the art of coding multidimensional database management software and GUI software will readily understand how to modify such software in accordance with the present invention. As noted above, the modified software does “behind the back” of the user what the user him/herself could have done using conventional database management software but with considerably more effort.

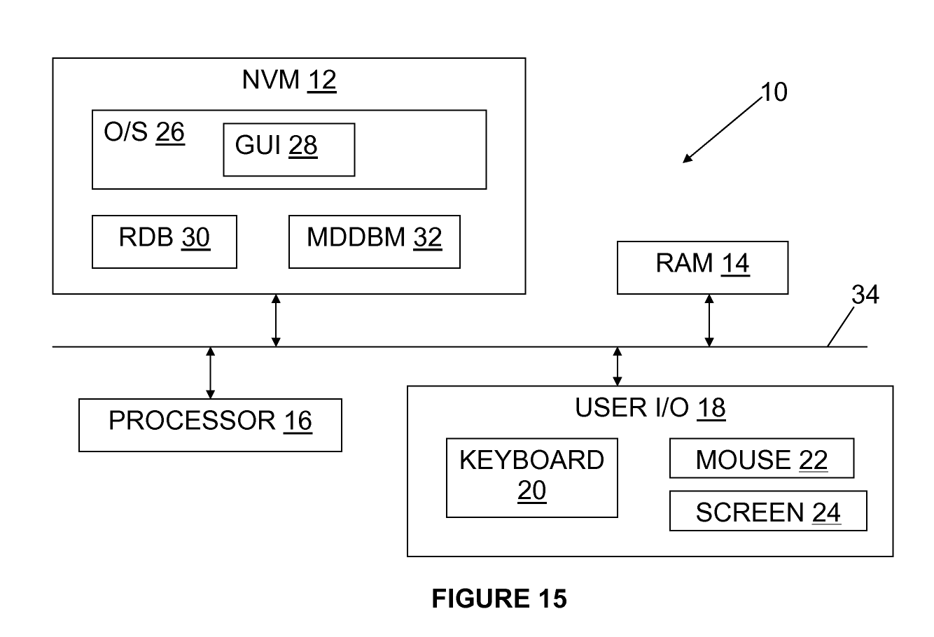

FIG. 15 is a high-level partial block diagram of a computer system 10 for displaying database queries according to the present invention. For clarity of illustration, only the components of system 10 that are directly relevant to the present invention are illustrated in FIG. 18. Device 10 includes a non-volatile memory (NVM) 12, a random access memory (RAM) 14, a processor 16 and user input/output devices 18 such as a keyboard 20, a mouse 22 and a screen 24, all communicating with each other via a bus 34. An operating system (0/S) 26 of the device is stored in non-volatile memory 12, as are a relational database (RDB) 30 and multidimensional database management (MDDBM) code 32. O/S 26 includes GUI code 28.

Under the control of O/S 24, processor 16 loads MDDBM code 32 into RAM 14 and executes MDDBM code 32 from RAM 14. MDDBM code is conventional MDDBM code, for extracting database queries from RDB 30, modified according to the principles of the present invention to interact with GUI code 28 to allow a user of system 10 to display the database queries as described above.

Non-volatile memory 12 is an example of a computer-readable storage medium bearing computer-readable code for implementing the interactive database query display methodology described herein. Other examples of such computer-readable storage media include read-only memories such as CDs bearing such code.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method of presenting, on a computer system, a plurality of views of a plurality of database queries, each database query having a respective plurality of dimensions, with each dimension including a plurality of elements, the method comprising:
(a) receiving, from a user of the computer system, a selection of a set of the elements of one of the dimensions of a first one of the database queries to parameterize;
(b) in response to said selection: parameterizing said set, thereby transforming said set into a parameter;
(c) presenting, to said user, a display of the views simultaneously using a graphical user interface (GUI) of the computer system;
(d) receiving, from said user, via an input device of said GUI, at least one instruction to propagate said parameter from a source field displayed by said GUI to at least one of the views that is a target view of said instruction; and
(e) in response to said instruction: propagating said parameter to said at least one target view.

2. The method of claim 1, wherein said selection is received via said GUI.

3. The method of claim 1, wherein said field is separate from said views.

4. The method of claim 1, wherein said source field is a view of said first database query and said at least one target view includes a view of a second database query.

5. The method of claim 1, wherein said at least one instruction is a graphical instruction.

6. The method of claim 5, wherein said at least one graphical instruction includes an instruction to draw a respective line from said source field to each said at least one target view.

7. A computer-readable storage medium having non-transient computer-readable code embodied on the computer-readable storage medium, the computer-readable code for presenting, on a computer system, a plurality of views of a plurality of database queries, each database query having a respective plurality of dimensions, with each dimension including a plurality of elements, the computer-readable code comprising:
(a) program code for receiving, from a user of the computer system, a selection of a set of the elements of one of the dimensions of a first one of the database queries to parameterize;
(b) program code for, in response to said selection: parameterizing said set, thereby transforming said set into a parameter;
(c) program code for presenting, to said user, a display of the views simultaneously using a graphical user interface (GUI) of the computer system;
(d) program code for receiving, from said user, via an input device of said GUI, at least one instruction to propagate said parameter from a source field displayed by said GUI to at least one of the views that is a target view of said instruction; and
(e) program code for, in response to said instruction: propagating said parameter to said at least one target view.
